(19) United States
(12) Patent Application Publication
(10) Pub. No.: US 2023/0090931 A1
(43) Pub. Date: Mar. 23, 2023

(54) DIFFERENT-MATERIAL FASTENER AND PRESSING TOOL OF DIFFERENT-MATERIAL FASTENING DEVICE USED TO PRESS DIFFERENT-MATERIAL FASTENER

(71) Applicant: SUBARU CORPORATION, Tokyo (JP)

(72) Inventors: Tsutomu HAGIWARA, Tokyo (JP); Hiroshi ASAKA, Tokyo (JP)

(73) Assignee: SUBARU CORPORATION, Tokyo (JP)

(21) Appl. No.: 17/929,520

(22) Filed: Sep. 2, 2022

(30) Foreign Application Priority Data
Sep. 21, 2021 (JP) 2021-153434

(51) Int. Cl. B21J 15/04; F16B 19/08; B21J 15/30; F16B 25/00; F16B 5/08

(52) U.S. Cl. CPC B21J 15/04; F16B 19/086; B21J 15/30; F16B 25/0031; F16B 5/08

(57) ABSTRACT

A different-material fastener fastens together a first member and a second member formed from a material different from a material of the first member. The different-material fastener includes a rivet and a stud. The rivet includes a shank configured to be pressed into the first member, and a first head disposed at one end of the shank. The first head has a diameter larger than a diameter of the shank. The stud includes a shaft protruding from a center of an upper surface of the first head, and a second head that is disposed at an end of the shaft. The second head has a diameter larger than a diameter of the shaft and smaller than the diameter of the first head.

### CROSS-REFERENCE TO RELATED APPLICATIONS

The present application claims priority from Japanese Patent Application No. 2021-153434 filed on Sep. 21, 2021, the entire contents of which are hereby incorporated by reference.

### BACKGROUND

The disclosure relates to a different-material fastener used to fasten different materials, and a pressing tool of a different-material fastening device used to press the different-material fastener.

A vehicle, for example, an automobile has a body partially formed from an aluminum panel for weight reduction. For example, Japanese Unexamined Patent Application Publication (JP-A) No. 2005-119577 describes a body structure including a body frame formed from a highly stiff steel panel and a body roof panel fastened to the body frame and formed from a lightweight aluminum panel.

To fasten such members formed from different metals, spot welding of joining different metals through fusion is impracticall due to a difference in, for example, the melting point or the coefficient of linear expansion between those metals. Thus, to fasten different materials, mechanical fastening using fasteners such as rivets is employed.

A roof molding, which is an exterior member, is attached to fastening surfaces of the body frame and the roof panel. As described in JP-A No. 2005-219534, this roof molding is assembled by being locked on a stud with a T-shaped cross section standing on the fastening surfaces of the body frame and the roof panel. After the body frame and the roof panel are fastened together with a fastener, the stud is attached to the fastening surfaces by welding.

### SUMMARY

An aspect of the disclosure provides a different-material fastener configured to fasten a first member and a second member formed from a material different from a material of the first member. The different-material fastener includes a rivet and a stud. The rivet includes a shank configured to be pressed into the first member, and a first head disposed at one end of the shank. The first head has a diameter larger than a diameter of the shank. The stud includes a shaft protruding from a center of an upper surface of the first head, and a second head disposed at an end of the shaft. The second head has a diameter larger than a diameter of the shaft and smaller than the diameter of the first head.

An aspect of the disclosure provides a pressing tool of a different-material fastening device applicable to the different-material fastener. The pressing tool includes a presser. The presser includes an end face and a recess in the end face configured to accommodate the stud. While the rivet is set in a position of fastening the first member, the pressing tool is configured to bring the end face into contact with the first head of the rivet and apply a pressing force on the first head toward the shank.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to describe the principles of the disclosure.

FIG. 1 is a sectional view of a different-material fastener and a different-material fastening device according to an embodiment of the disclosure;

FIG. 2A is a side view of the different-material fastener;

FIG. 2B is a plan view of the different-material fastener;

FIG. 3A is a sectional view of the procedure of fastening a first member and a second member together;

FIG. 3B is a sectional view of the procedure of fastening the first member and the second member together;

FIG. 3C is a sectional view of the procedure of fastening the first member and the second member together;

FIG. 3D is a sectional view of the procedure of fastening the first member and the second member together;

FIG. 4 is a sectional view of a different-material fastener and a different-material fastening device according to an embodiment;

FIG. 5 is a perspective view of a different-material fastener according to an embodiment;

FIG. 6A is a sectional view of the procedure of fastening a first member and a second member together using the different-material fastener and a different-material fastening device according to the embodiment;

FIG. 6B is a sectional view of the procedure of fastening the first member and the second member together using the different-material fastener and the different-material fastening device according to the embodiment;

FIG. 7 is a perspective view of a different-material fastener according to an embodiment;

FIG. 8A is a sectional view of the procedure of fastening a first member and a second member together using the different-material fastener and a different-material fastening device according to the embodiment;

FIG. 8B is a sectional view of the procedure of fastening the first member and the second member together using the different-material fastener and the different-material fastening device according to the embodiment;

FIG. 9A is a sectional view of the procedure of fastening a first member and a second member together using a different-material fastener and a different-material fastening device according to an embodiment; and

FIG. 9B is a sectional view of the procedure of fastening the first member and the second member together using the different-material fastener and the different-material fastening device according to the embodiment.

### DETAILED DESCRIPTION

Assembly of a roof panel and a roof molding formed from different materials to a body frame involves use of a fastening device that fastens the body frame and the roof panel together with rivets, and a welding device that welds studs to attach the roof molding to the fastening surfaces. The assembly thus involves use of two different devices. Thus, the cost of equipment rises, and the space for equipment increases.

It is desirable to provide a different-material fastener that can reduce the cost of equipment or the space for equipment used to fasten different materials and attach studs, and to provide a pressing tool of a different-material fastening device used to press the different-material fastener.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### First Embodiment

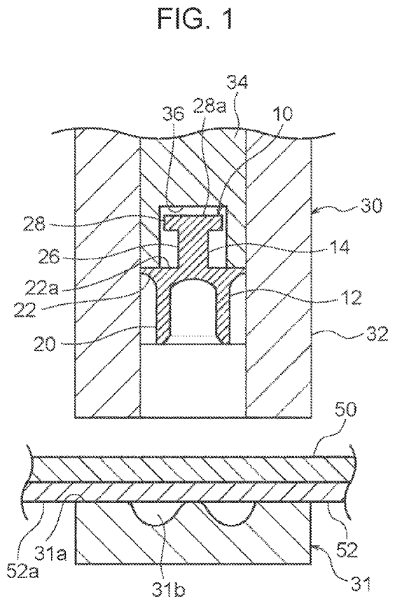

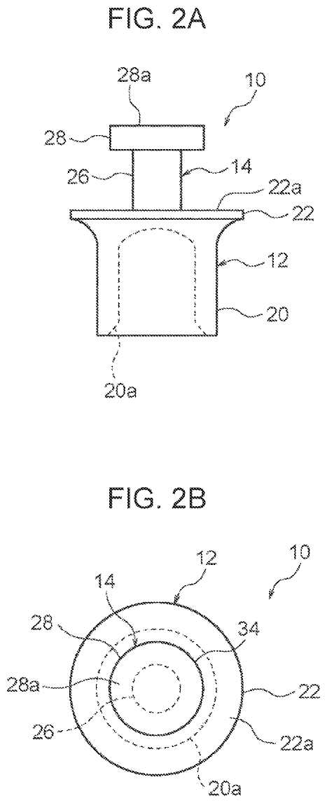

FIG. 1 is a sectional view of a different-material fastener 10 and a different-material fastening device 30 including a pressing tool according to a first embodiment of the disclosure. FIG. 2A is a side view of the different-material fastener 10 and FIG. 2B is a plan view of the different-material fastener 10. The different-material fastener 10 is used to fasten two or more members formed from different materials.

The first embodiment describes a case where two metal members formed from different materials, for example, a first member 50 formed from aluminum or an aluminum alloy and a second member 52 formed from steel stiffer than the first member 50 are fastened together with a different-material fastener 10. The first member 50 and the second member 52 have a plate shape at fastened portions and are fastened together by the different-material fasteners 10 with the first member 50 stacked on the second member 52.

Each different-material fastener 10 includes a rivet 12 used for different-material fastening and a stud 14 undetachably joined to the rivet 12. The rivet 12 includes a shank 20 capable of being pressed into the first member 50, and a first head 22 disposed at one end of the shank 20 and having a diameter larger than a diameter of the shank 20. The stud 14 includes a shaft 26 that protrudes from a center of an upper surface 22a of the first head 22, and a second head 28 disposed at an end of the shaft 26. In the following description, the first head 22 is also referred to as a rivet head 22, and the second head 28 is also referred to as a stud head 28.

In the first embodiment, the rivet 12 is a self-piercing rivet that fastens the first member 50 and the second member 52 through riveting. As illustrated in FIG. 2A and FIG. 2B, the shank 20 of the rivet 12 has a substantially cylindrical shape and has a tapered end 20a further from the rivet head 22. The rivet head 22 has a substantially disk shape and has the upper surface 22a, which is planar and to which the stud 14 is attached. The rivet head 22 has a diameter larger than an outer diameter of the shank 20. The length of the shank 20 in an axial direction is larger than a thickness of the first member 50.

In the first embodiment, the stud 14 is a T stud having a T-shaped cross section as illustrated in FIG. 1. The shaft 26 of the stud 14 is a solid cylinder extending from the rivet head 22 coaxially with the shank 20. The outer diameter of the shaft 26 is smaller than the outer diameter of the shank 20. The stud head 28 has a disk shape coaxial with the shaft 26. The outer diameter of the stud head 28 is larger than the outer diameter of the shaft 26 and smaller than the outer diameter of the rivet head 22. The rivet 12 and the stud 14 are formed from the same material, and may be formed from a metal material such as steel or an aluminum alloy.

Subsequently, the different-material fastening device 30 applicable to the different-material fastener 10 will be described. By simply changing the shape of a punch that exerts a pressing force to a rivet, an existing different-material fastening device applicable to an existing different-material fastening rivet not including the stud 14 may be used for the above-described different-material fastener 10. In one embodiment, the punch may serve as a “pressing tool”. As illustrated in FIG. 1, the different-material fastening device 30 includes a die 31 that supports a back surface 52a of the second member 52, a holder 32 that presses the first and second members 50 and 52 against the die 31, and a punch 34 that drives the different-material fastener 10 into the first member 50 and the second member 52. The punch 34 serves as a pressing tool that comes into contact with the rivet head 22 of the different-material fastener 10 and exerts a pressing force on the rivet head 22 toward the shank 20.

The die 31 has a cavity 31b having a recessed shape in a top surface 31a facing the punch 34. The cavity 31b is annularly recessed in plan view, while having, at the center, a protuberance serving as an inner wall surface.

The holder 32 has a tubular shape extending in a top-bottom direction and is disposed to be coaxial with the cavity 31b. The punch 34 is cylindrical and is movable in the holder 32 in the axial direction by a driving device not illustrated. The outer diameter of the punch 34 is substantially the same as the outer diameter of the rivet head 22. The punch 34 has a recess 36 in a far end surface 34a, that is, a surface that comes into contact with the different-material fastener 10. The recess 36 accommodates the stud 14 of the different-material fastener 10. The recess 36 has a size that can accommodate the entirety of the stud 14. In the first embodiment, the recess 36 having a cylindrical shape is formed in the far end surface 34a of the punch 34.

Subsequently, the procedure of fastening to-be-fastened members, or the first member 50 and the second member 52, together with the above-described different-material fastener 10 and the different-material fastening device 30 will be described.

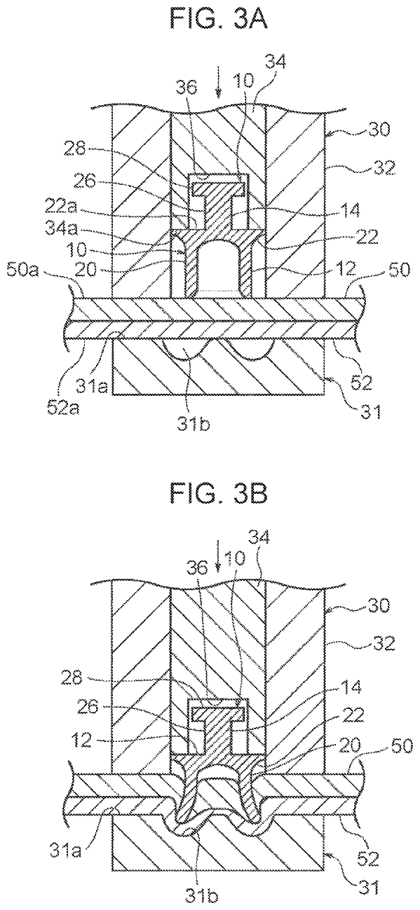

First, as illustrated in FIG. 1, the second member 52 and the first member 50 are stacked on the die 31 one on the other in this order. Then, the holder 32 is brought into contact with a surface 50a of the first member 50 to press the to-be-fastened members against the die 31. The different-material fastener 10 is held in the holder 32 while being disposed below the punch 34. At this time, the stud 14 of the different-material fastener 10 is accommodated in the recess 36 of the punch 34. Thereafter, as illustrated in FIG. 3A, by receiving a pressing force from a driving device, the punch 34 moves downward inside the holder 32 toward the die 31. Thus, the different-material fastener 10 is driven into the to-be-fastened members.

In this driving, as illustrated in FIG. 3B and FIG. 3C, the hollow shank 20 of the different-material fastener 10 penetrates the first member 50. As the shank 20 penetrates further, the second member 52 pressed by the shank 20 and the first member 50 is plastically deformed toward the bottom surface of the cavity 31b. After part of the second member 52 arriving at the bottom surface of the cavity 31b, the second member 52 is plastically deformed to follow the inner wall surface of the cavity 31b, and the end of the shank 20 cuts into the second member 52 while widening the diameter. Thus, as illustrated in FIG. 3D, the first member 50 and the second member 52 are riveted with the rivet 12 of the different-material fastener 10. In the fastened state, the rivet head 22 of the different-material fastener 10 is substantially flush with the surface 50a of the first member 50, and the stud 14 protrudes from the surface 50a. The stud 14 can be used as a fastener that attaches a component to an integrated body including the first member 50 and the second member 52.

As described above, the different-material fastening device 30 according to the first embodiment has the recess 36 in the punch 34 to accommodate the stud 14. Thus, the rivet 12 of the different-material fastener 10 can fasten the different materials together without being affected by the stud 14. Concurrently with fastening the members formed from different materials together, the different-material fastener 10 according to the first embodiment can attach, to the integrated body, the stud 14 having a fastening function of attaching another member. Thus, for example, when the different-material fastener 10 fastens an aluminum-alloy roof panel and a steel body frame together, a body assembly process can eliminate the operation of welding the stud to attach the roof molding to the fastened portions of the roof panel and the body frame. The different-material fastener 10 and the different-material fastening device 30 according to the first embodiment can thus concurrently perform, with a single device, fastening of the different members and attachment of the stud 14. Thus, the cost of equipment and the space for equipment can be reduced in the body assembly process.

In FIG. 3A to FIG. 3C, the different-material fastening device 30 leaves a gap between the stud 14 of the different-material fastener 10 and the inner wall surface of the recess 36 of the punch 34. However, in the state of the different-material fastener 10 where the stud 14 is accommodated in the recess 36, the inner wall surface of the recess 36 may be in contact with the upper surface of the stud head 28. In such a case, when the punch 34 presses the rivet head 22 of the different-material fastener 10, the stud head 28 of the different-material fastener 10 is pressed toward the rivet 12 by the inner wall surface of the recess 36, and thus, the different-material fastener 10 can be driven into the to-be-fastened members with a greater force.

Subsequently, a different-material fastener 10 and a different-material fastening device 30 according to other embodiments will be described. In second to fifth embodiments described below, components the same as those of the first embodiment are denoted with the same reference signs without being described.

### Second Embodiment

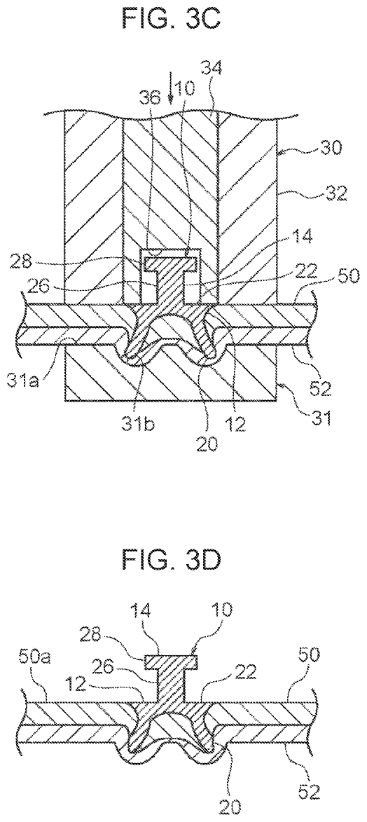

Similarly to FIG. 3A, FIG. 4 is a sectional view of a different-material fastener 10 and a different-material fastening device 30 according to a second embodiment. In the second embodiment, the different-material fastener 10 differs from that of the first embodiment in the shape of the stud head 28, and the different-material fastening device 30 differs from that of the first embodiment in the shape of the recess 36. Other components are the same as those of the first embodiment.

The stud head 28 according to the second embodiment has a circular profile in plan view and has a longitudinal cross section, taken along the center axis, of a substantially V shape to radially widen as being spaced further apart from the shaft 26, as illustrated in FIG. 4. The stud head 28 has, at its end, an inclined surface 29 inclined with respect to the axial direction of the shaft 26.

The punch 34 of the different-material fastening device 30 has, at part of the inner wall surface of the recess 36 in which the stud 14 is accommodated, a contact surface 39 that comes into contact with the inclined surface 29 of the stud head 28. The contact surface 39 is an inclined surface that faces and comes into contact with the inclined surface 29, and extends throughout the circumference of the columnar recess 36.

With the different-material fastener 10 and the different-material fastening device 30 according to the second embodiment, to drive the different-material fastener 10 with the punch 34, the contact surface 39 comes into contact with the inclined surface 29 of the stud head 28 and presses the inclined surface 29 to apply a force of pressing the shank 20 of the rivet 12 into the to-be-fastened members as indicated with arrows in FIG. 4. Thus, the accuracy of pressing the rivet 12 can be improved.

### Third Embodiment

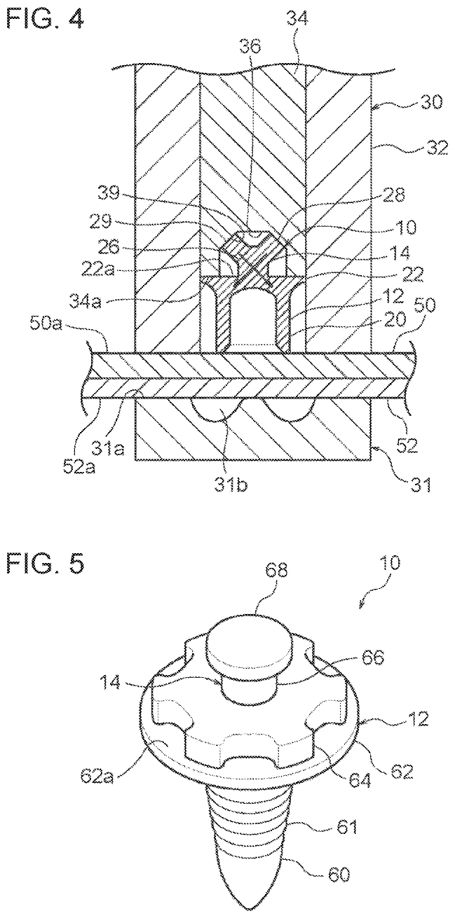

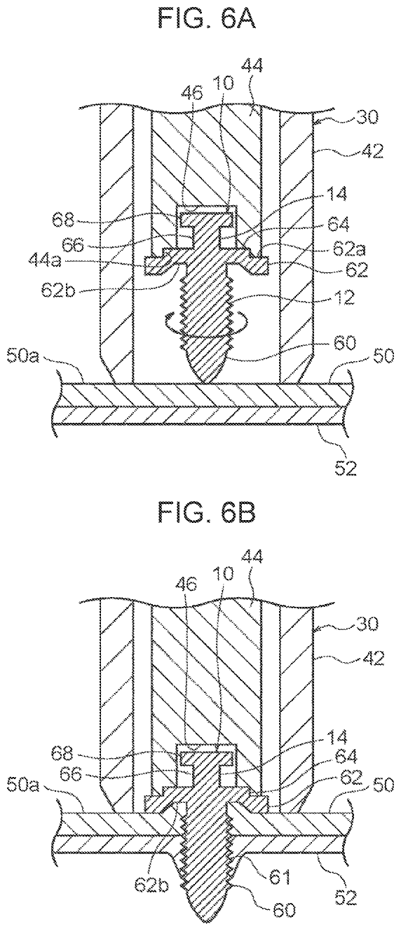

Subsequently, a different-material fastener 10 and a different-material fastening device 30 according to a third embodiment will be described. FIG. 5 is a perspective view of the different-material fastener 10 according to the third embodiment. Similarly to FIG. 3A and FIG. 3C, FIG. 6A and FIG. 6B are sectional views of the procedure of fastening the first member 50 and the second member 52 together with the different-material fastener 10 and the different-material fastening device 30 according to the third embodiment.

The different-material fastener 10 according to the third embodiment fastens the first member 50 and the second member 52 together by screwing the rivet 12. The rivet 12 includes a solid, substantially cylindrical shank 60, and a rivet head 62 serving as a first head disposed at one end of the shank 60. The shank 60 has a screw thread 61 on the outer peripheral surface and has a tapered end. The rivet head 62 has a larger diameter than the shank 60 and has an engageable portion 64 protruding on an upper surface 62a of a disk-shaped body. The engageable portion 64 is to be engaged with a presser 44 serving as a pressing tool of the different-material fastening device 30. A groove 62b recessed toward the upper surface 62a along the outer circumference of the shank 60 is formed in the back surface of the rivet head 62. The rivet 12 according to the third embodiment serves as a flow drilling screw that is rotated to be driven into the first member 50 and the second member 52.

The stud 14 of the different-material fastener 10 includes a shaft 66 protruding from the center of the rivet head 62, and a stud head 68 or a second head disposed at the end of the shaft 66. The stud head 68 has a diameter larger than the diameter of the shaft 66 and smaller than the diameter of the rivet head 62. As in the first embodiment, the stud 14 according to the third embodiment forms a T stud having a T-shaped cross section.

As illustrated in FIG. 6A, the different-material fastening device 30 includes a hollow cylindrical supporter 42, and a solid cylindrical presser 44 disposed inside the supporter 42 to be movable upward and downward in the axial direction and rotatable about the axis. The presser 44 has, on its far end surface, an engageable groove 44a extending in the circumferential direction. The engageable groove 44a is to be engaged with the engageable portion 64 of the different-material fastener 10. The presser 44 has a recess 46 at the center of the far end surface to accommodate the stud 14 of the different-material fastener 10.

As illustrated in FIG. 6A, with the different-material fastener 10 and the different-material fastening device 30 according to the third embodiment, when the different-material fastener 10 is set to the position of fastening the first member 50 and the second member 52 together, and the engageable portion 64 of the different-material fastener 10 is engaged with the engageable groove 44a of the presser 44, the stud 14 is accommodated in the recess 46 of the presser 44. When the presser 44 in this state is pressed against the to-be-fastened members while being rotated at a high speed, the different-material fastener 10 rotates together with the presser 44, the rotation causes frictional heat, the frictional heat softens the first member 50 and the second member 52, and the shank 60 of the different-material fastener 10 penetrates the first member 50 and the second member 52.

As illustrated in FIG. 6B, when fastening is completed, plastic flow of the first member 50 and the second member 52 forms a screw thread caused by the to-be-fastened members around the screw thread 61, and the material of the first member 50 flows into the groove 62b of the rivet head 62.

### Fourth Embodiment

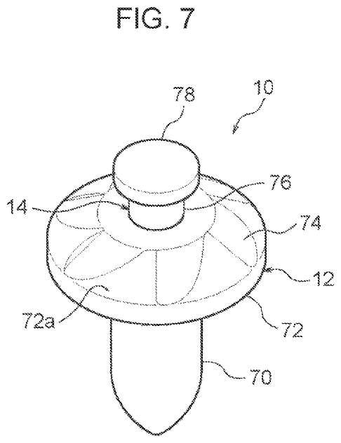

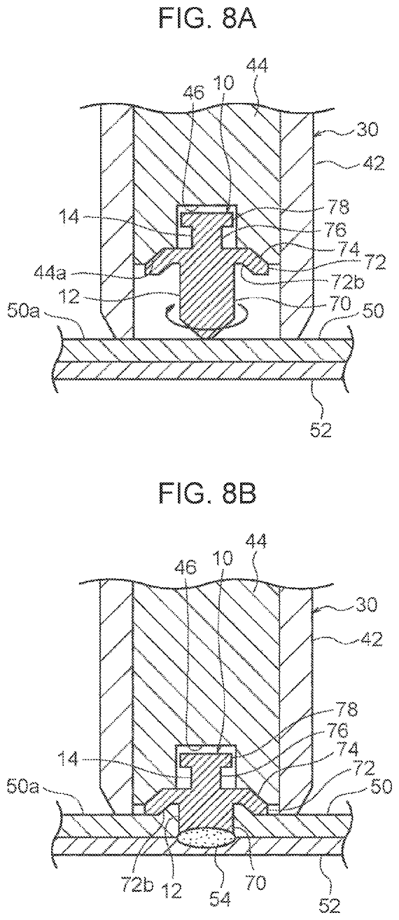

Subsequently, a different-material fastener 10 and a different-material fastening device 30 according to a fourth embodiment will be described. FIG. 7 is a perspective view of the different-material fastener 10 according to the fourth embodiment. Similarly to FIG. 3A and FIG. 3C, FIG. 8A and FIG. 8B are sectional views of the procedure of fastening the first member 50 and the second member 52 together with the different-material fastener 10 and the different-material fastening device 30 according to the fourth embodiment.

The different-material fastener 10 according to the fourth embodiment fastens the first member 50 and the second member 52 together by fit welding with the rivet 12. The rivet 12 is formed from an iron material and includes a solid, substantially cylindrical shank 70 and a rivet head 72 serving as a first head disposed at one end of the shank 70. The end of the shank 70 is pointed. The rivet head 72 has a larger diameter than the shank 70 and has an engageable portion 74 protruding on an upper surface 72a of a disk-shaped body. The engageable portion 74 is to be engaged with the presser 44 serving as a pressing tool of the different-material fastening device 30. A groove 72b recessed toward the upper surface 62a and extending along the outer circumference of the shank 70 is formed in the back surface of the rivet head 72.

The stud 14 is undetachably joined to the rivet 12 and forms a T stud having a T-shaped cross section as in the first embodiment. The stud 14 includes a shaft 76 protruding from the center of the rivet head 72, and a stud head 78 serving as a second head disposed at the end of the shaft 76. The stud head 78 has a diameter larger than the diameter of the shaft 76 and smaller than the diameter of the rivet head 72.

As illustrated in FIG. 8A, the different-material fastening device 30 includes a hollow cylindrical supporter 42, a solid cylindrical presser 44 disposed inside the supporter 42 to be movable upward and downward in the axial direction and rotatable about the axis. The presser 44 has, on its far end surface, the engageable groove 44a in the circumferential direction. The engageable groove 44a is to be engaged with the engageable portion 74 of the different-material fastener 10. The presser 44 has the recess 46 at the center of the far end surface to accommodate the stud 14.

With the different-material fastener 10 and the different-material fastening device 30 according to the fourth embodiment, as illustrated in FIG. 8A, when the different-material fastener 10 is set in the position of fastening the first member 50 and the second member 52 together, and the engageable portion 74 of the different-material fastener 10 is engaged with the engageable groove 44a of the presser 44, the stud 14 is accommodated in the recess 46 of the presser 44. When the presser 44 in this state is pressed against the to-be-fastened members while being rotated at a high speed, the rotation causes frictional heat, the frictional heat allows the shank 70 of the different-material fastener 10 to penetrate the first member 50 as illustrated in FIG. 8B, and the end of the shank 70 causes friction stir welding with the second member 52. In addition, the material of the first member 50 flows in the groove 72b of the rivet head 72 due to plastic flow to be in a fitted state.

### Fifth Embodiment

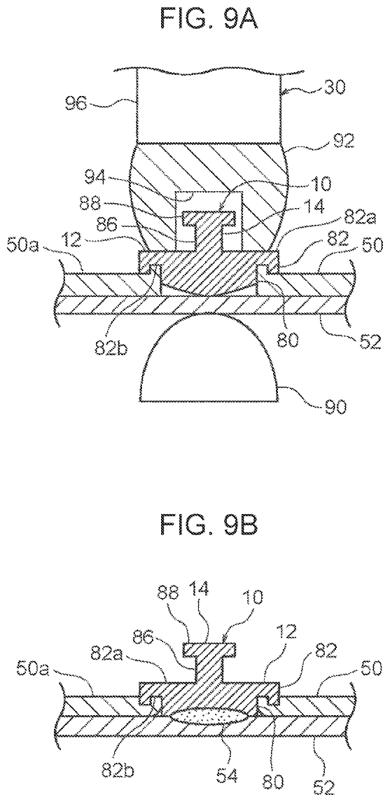

Subsequently, a different-material fastener 10 and a different-material fastening device 30 according to a fifth embodiment will be described. FIG. 9A and FIG. 9B are sectional views of the procedure of fastening the first member 50 and the second member 52 together with the different-material fastener 10 and the different-material fastening device 30 according to the fifth embodiment.

The different-material fastener 10 according to the fifth embodiment fastens the first member 50 and the second member 52 together by fit welding with the rivet 12. The rivet 12 is formed from iron and includes a solid, substantially cylindrical shank 80 and a rivet head 82 serving as a first head disposed at one end of the shank 80. The end of the shank 80 is pointed. The rivet head 82 has a disk shape with a larger diameter than the shank 80. A groove 82b recessed toward an upper surface 82a and extending along the outer circumference of the shank 80 is formed in the back surface of the rivet head 82.

The stud 14 is undetachably joined to the rivet 12 and forms a T stud having a T-shaped cross section as in the first embodiment. The stud 14 includes a shaft 86 protruding from the center of the rivet head 82, and a stud head 88 serving as a second head disposed at the end of the shaft 86. The stud head 88 has a diameter larger than the diameter of the shaft 86 and smaller than the diameter of the rivet head 82.

As illustrated in FIG. 9A, the different-material fastening device 30 includes a first electrode 90 and a second electrode 92 disposed to face the first electrode 90. Either one of the first electrode 90 and the second electrode 92 is movable toward or away from the other electrode. The second electrode 92 serves as a pressing tool that exerts a pressing force to the different-material fastener 10 to fasten the first and second members 50 and 52 together. The outer diameter of the second electrode 92 is larger than the outer diameter of the stud head 28. The end of the second electrode 92 is planar to come into contact with the flat upper surface 82a of the rivet head 82 of the different-material fastener 10, and has, at its center, a cylindrical recess 94 that can accommodate the stud 14 of the different-material fastener 10.

The different-material fastening device 30 according to the fifth embodiment drives the different-material fastener 10 into the first member 50 to rivet the first member 50 with the rivet 12 of the different-material fastener 10, and then, as illustrated in FIG. 9A, the second member 52 and the different-material fastener 10 are held between the first and second electrodes 90 and 92 to pass a current between the electrodes while receiving a pressing force. Thus, the rivet 12 of the different-material fastener 10 and the second member 52 are welded together, and as illustrated in FIG. 9B, a nugget 54 is formed on their joined surfaces. Thus, the first member 50 and the second member 52 are fastened together.

As described above, with the different-material fastener 10 and the different-material fastening device 30 according to each of the third to fifth embodiments, the presser 44 or the second electrode 92 serving as a pressing tool has the recess 46 or a recess 96 that accommodates the stud 14. Thus, the rivet 12 of the different-material fastener 10 can fasten together the first member 50 and the second member 52 formed from different materials without being affected by the stud 14. Concurrently with fastening different materials together, the stud 14 having a function as a fastener to attach another member can be attached to this integrated body. The stud head 28 of the different-material fastener 10 having the inclined surface 29 and the pressing tool having the contact surface 39 in the recess 36 described in the second embodiment may also be applied to the third to fifth embodiments.

The disclosure is not limited to the above embodiment or modification examples, and may be changed in various manners within the scope not departing from the gist of the disclosure.

The different-material fastener and the pressing tool of the different-material fastening device according to each of the embodiments of the disclosure can reduce the cost of equipment or the space for equipment used to fasten different materials together and to attach studs.

1. A different-material fastener configured to fasten together a first member and a second member formed from a material different from a material of the first member, the different-material fastener comprising:
a rivet comprising a shank configured to be pressed into the first member, and a first head disposed at one end of the shank, the first head having a diameter larger than a diameter of the shank; and
a stud comprising a shaft protruding from a center of an upper surface of the first head, and a second head disposed at an end of the shaft, the second head having a diameter larger than a diameter of the shaft and smaller than the diameter of the first head.

2. The different-material fastener according to claim 1, wherein the rivet fastens the first member and the second member together by any one of riveting, fit welding, and screwing.

3. A pressing tool of a different-material fastening device applicable to the different-material fastener according to claim 1, the pressing tool comprising an presser, the presser including an end face and a recess in the end face configured to accommodate the stud, the pressing tool being configured to bring the end face into contact with the first head of the rivet and apply a pressing force on the first head toward the shank while the rivet is set in a position of fastening the first member.

4. A pressing tool of a different-material fastening device applicable to the different-material fastener according to claim 2, the pressing tool comprising an presser, the presser including an end face and a recess in the end face configured to accommodate the stud, the pressing tool being configured to bring the end face into contact with the first head of the rivet and apply a pressing force on the first head toward the shank while the rivet is set in a position of fastening the first member.

5. The pressing tool according to claim 3,
wherein, in a case where the stud of the different-material fastener is accommodated in the recess and presses the first head of the rivet, the pressing tool presses, with an inner wall surface of the recess, the second head of the different-material fastener toward the rivet.

6. The pressing tool according to claim 4,
wherein, in a case where the stud of the different-material fastener is accommodated in the recess and presses the first head of the rivet, the pressing tool presses, with an inner wall surface of the recess, the second head of the different-material fastener toward the rivet.

7. The pressing tool according to claim 3,
wherein the second head of the different-material fastener has a substantially V shape radially widening further as the second head is spaced further apart from the shaft, and comprises, at an end of the second head, an inclined surface inclined with respect to an axial direction of the shaft, and
wherein the recess of the pressing tool comprises, at part of the inner wall surface, a contact surface configured to come into contact with the inclined surface.

8. The pressing tool according to claim 4,
wherein the second head of the different-material fastener has a substantially V shape radially widening further as the second head is spaced further apart from the shaft, and comprises, at an end of the second head, an inclined surface inclined with respect to an axial direction of the shaft, and
wherein the recess of the pressing tool comprises, at part of the inner wall surface, a contact surface configured to come into contact with the inclined surface.

9. The pressing tool according to claim 5,
wherein the second head of the different-material fastener has a substantially V shape radially widening further as the second head is spaced further apart from the shaft, and comprises, at an end of the second head, an inclined surface inclined with respect to an axial direction of the shaft, and
wherein the recess of the pressing tool comprises, at part of the inner wall surface, a contact surface configured to come into contact with the inclined surface.

10. The pressing tool according to claim 6,
wherein the second head of the different-material fastener has a substantially V shape radially widening further as the second head is spaced further apart from the shaft, and comprises, at an end of the second head, an inclined surface inclined with respect to an axial direction of the shaft, and
wherein the recess of the pressing tool comprises, at part of the inner wall surface, a contact surface configured to come into contact with the inclined surface.
